(19) United States
(12) Patent Application Publication
(10) Pub. No.: US 2023/0021922 A1
(43) Pub. Date: Jan. 26, 2023

(54) SYSTEM AND METHOD FOR AUTOMATED PARKING OF A VEHICLE

(71) Applicant: Continental Autonomous Mobility US, LLC, Auburn Hills, MI (US)

(72) Inventors: Joseph Burtch, Lake Orion, MI (US); Nizar Ahamed, Farmington Hills, MI (US); James Hockridge Critchley, Lake Orion, MI (US); Sina Davani, Troy, MI (US); Nithin Joseph Pathalil, Lake Orion, MI (US)

(73) Assignee: Continental Autonomous Mobility US, LLC, Auburn Hills, MI (US)

(21) Appl. No.: 17/758,434

(22) PCT Filed: Jan. 6, 2021
(86) PCT No.: PCT/US2021/070004

§ 371 Date: Jul. 6, 2022

Related U.S. Application Data
(60) Provisional application No. 62/957,567, filed on Jan. 6, 2020.

(51) Int. Cl. B60W 30/06; G01C 21/00; B60W 60/00

(52) U.S. Cl. CPC B60W 30/06; G01C 21/3833; B60W 60/001

(57) ABSTRACT

A method of parking a vehicle includes creating a map of a parking environment utilizing data from at least one sensor coupled to a vehicle. The method further includes storing the map in a data storage device. The method also includes receiving a first learn signal indicating that the vehicle is located in a first parking position. The method further includes determining a first set of spatial data indicative of the location of the vehicle relative to the map in response to receiving the first learn signal. The method also includes storing the first set of spatial data in the data storage device.

### CROSS REFERENCE TO RELATED APPLICATION

This application claims priority to U.S. provisional patent application No. 62/957,567, filed Jan. 6, 2020, which is hereby incorporated by reference.

### TECHNICAL FIELD

The technical field relates generally to autonomous or semi-autonomous vehicles.

### BRIEF SUMMARY

In one exemplary embodiment, a method of parking a vehicle includes creating a map of a parking environment utilizing data from at least one sensor coupled to a vehicle. The method further includes storing the map in a data storage device. The method also includes receiving a first learn signal indicating that the vehicle is located in a first parking position. The method further includes determining a first set of spatial data indicative of the location of the vehicle relative to the map in response to receiving the first learn signal. The method also includes storing the first set of spatial data in the data storage device.

### BRIEF DESCRIPTION OF THE DRAWINGS

Other advantages of the disclosed subject matter will be readily appreciated, as the same becomes better understood by reference to the following detailed description when considered in connection with the accompanying drawings wherein:

FIG. 1 is a top view of a vehicle implemented with a vehicle parking system according to one exemplary embodiment;

FIG. 2 is a flowchart of a method of parking a vehicle according to one exemplary embodiment; and

FIGS. 3-11 are images showing various steps of the method of parking the vehicle according to one or more exemplary embodiments.

### DETAILED DESCRIPTION

Referring to the Figures, wherein like numerals indicate like parts throughout the several views, a vehicle parking system 100 and method x00 of parking a vehicle is shown and described herein.

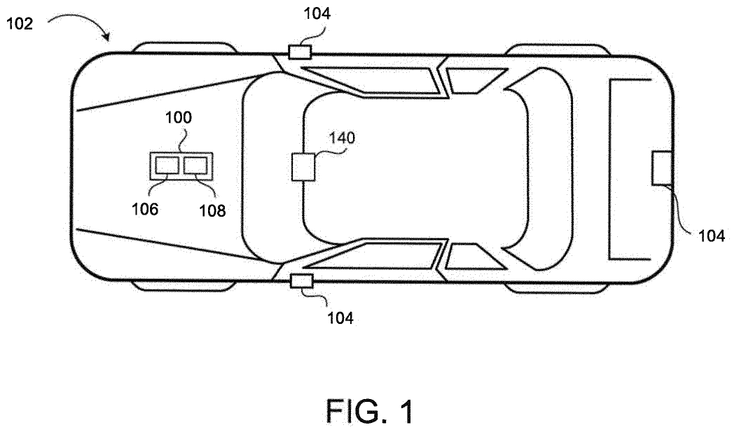

Referring to FIG. 1, a vehicle 102 may be equipped with the vehicle parking system 100. While the vehicle 102 in FIG. 1 represents an automobile having four wheels for travelling on land, it should be appreciated that the system 100 may be incorporated with other types of vehicles 102, including, but certainly not limited to, trucks, motorcycles, aircraft, watercraft (i.e., boats), agricultural implements, and military equipment.

The system 100 includes at least one sensor 104 for sensing an environment around at least a portion of the vehicle 102. The at least one sensor 104 may be implemented with a radar, lidar, camera, sonar, and/or other similar device. It should be appreciated that the system 100 may include multiple sensors 104. It should also be appreciated that the system may include multiple types of sensors 104.

The system 100 also includes a processor 106. The processor 106 is a device capable of performing calculations and/or performing a series of instructions (i.e., running a program). The processor 106 may be implemented with a microprocessor, microcontroller, applicant-specific integrated circuit (“ASIC”), a programmable logic device, a field-programmable gate array (“FPGA”), and/or other suitable device. It should be appreciated that the processor 106 described herein may be implemented with a single unit or multiple units. The processor 106 is in communication with the at least one sensor 104, such that, at least, data and/or information from the at least one sensor 104 may be received by the processor 106.

The system 100 also includes a data storage device 108 in communication with the processor 106. The data storage device 108 may be integrated with the processor 106, or may be a separate device, as is appreciated by those of ordinary skill in the art.

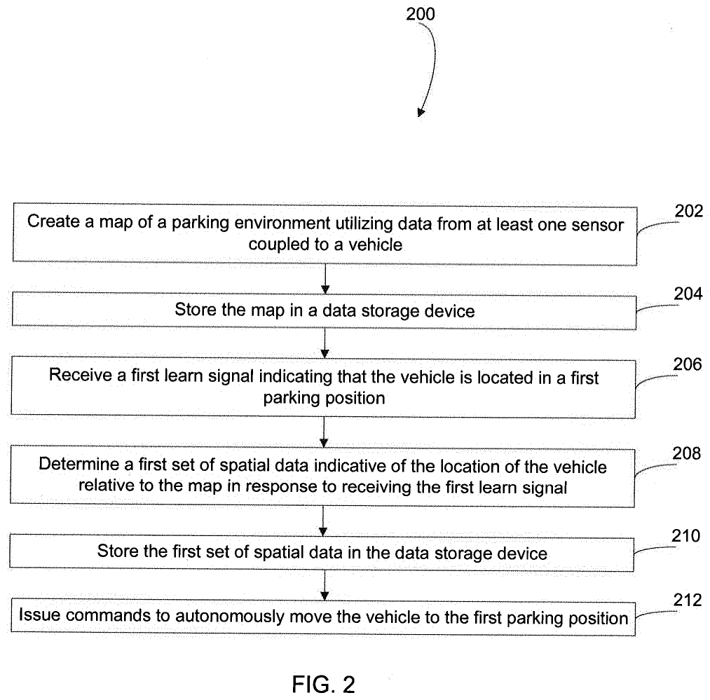

A method 200 of parking a vehicle 102 is shown in FIG. 2. The method 200 may be implemented using the system 100 or with other suitable devices.

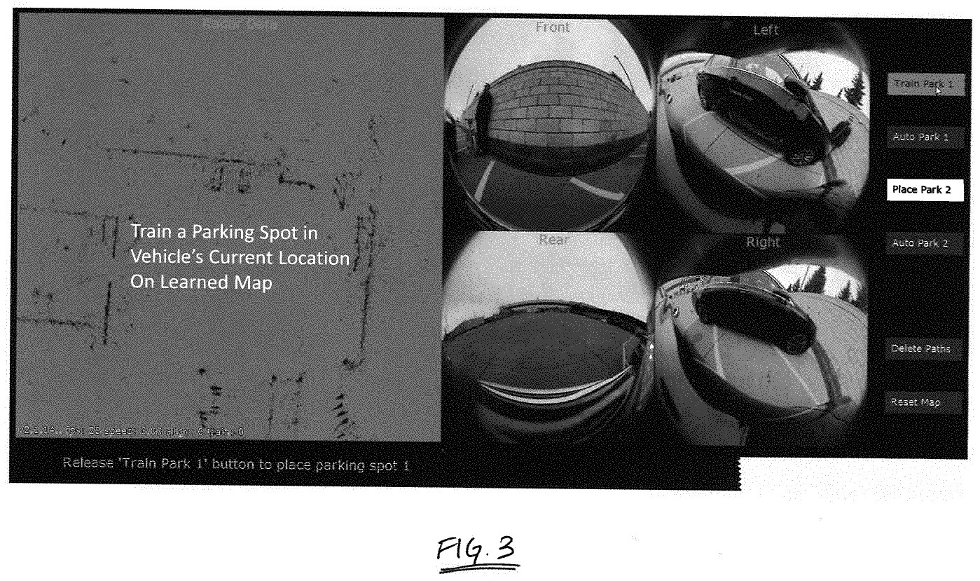

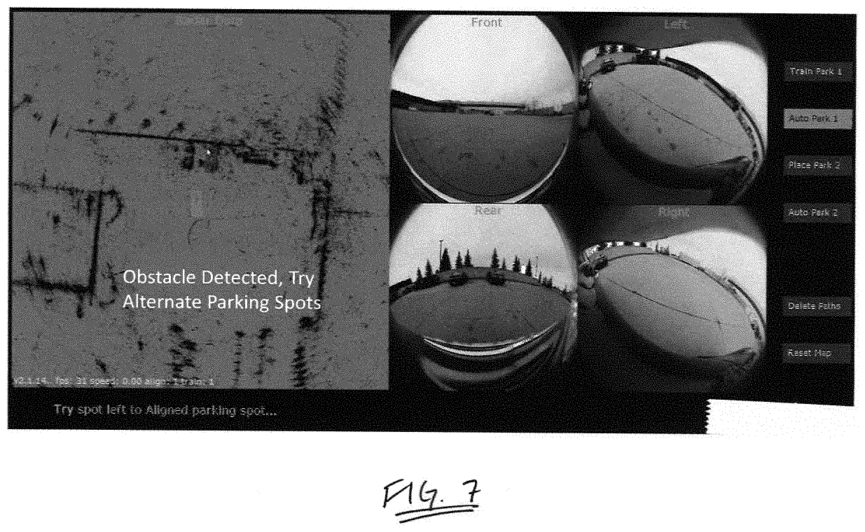

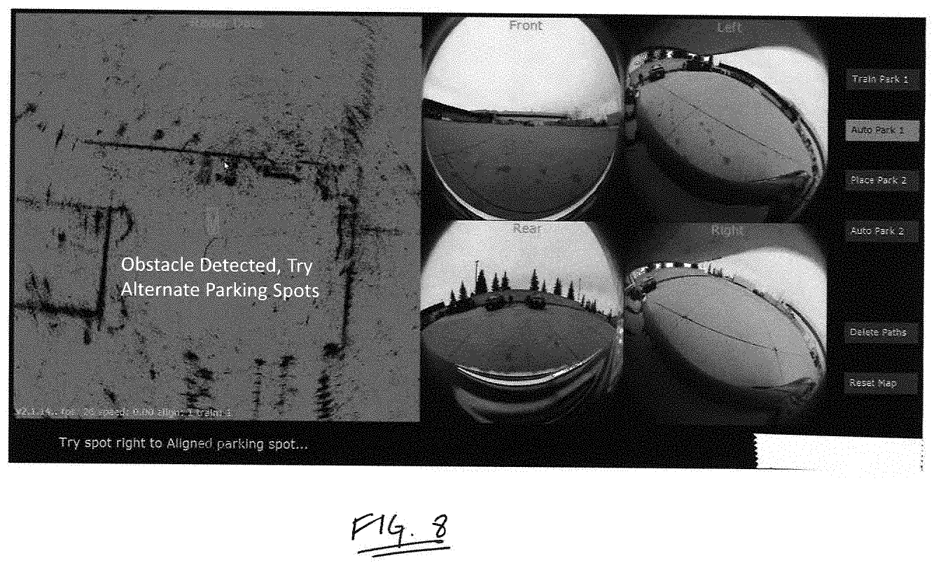

The method 200 includes, at 202, creating a map 300 of a parking environment 302 utilizing data from at least one sensor 104 coupled to the vehicle 102. In FIGS. 3-13, the map 300 is generated from data from radar units implemented as the at least one sensor 104. The map 300 indicates potential obstacles to the vehicle 102. For example, the potential obstacles may be a wall, fence, curb, pillar, other vehicle, vegetation, dock, pole, berm, sign post, construction marker, traffic cone, large toy, etc. The method 200 also includes, at 204, storing the map in the data storage device 108.

In one exemplary embodiment, the method 200 includes, at 206, receiving a first learn signal indicating that the vehicle is located in a first parking position. For example, and as shown in FIG. 3, a driver may maneuver the vehicle 102 to a preferred parking location, e.g., in a home garage, carport, or parking space. The drive may then indicate that the vehicle 102 is in the preferred parking location, e.g., by pressing a button, activating a switch, or giving a voice command to a human-machine interface (not shown). A first learn signal is then generated and sent to the processor 106.

The method 200 may further include, at 208, determining a first set of spatial data indicative of the location of the vehicle 102 relative to the map in response to receiving the first learn signal. Said another way, when the first learn signal is received by the processor 106, the processor 106 then records data reflecting the position of the vehicle 102 relative to structures and/or obstacles as sensed by the at least one sensor 104 and recorded on the map. The method 200 may further include, at 210, storing the first set of spatial data in the data storage device 108.

In one exemplary embodiment, the method 200 also includes, at 210, receiving a park signal indicating that an operator of the vehicle 102 would like the vehicle 102 to autonomously move to the first parking position. For example, in practice, once a preferred parking location is recorded, the operator of the vehicle 102 may indicate a desire for the vehicle 102 to autonomously move to said location. The operator may indicate such a desire, again, by pressing a button or by using a voice command.

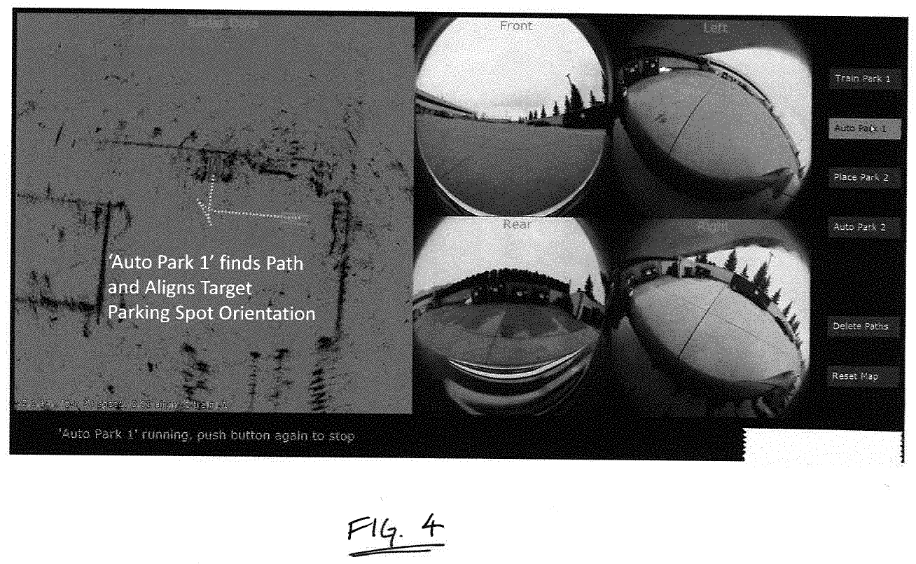

The method 200 may also include, at 212, issuing commands to autonomously move the vehicle 102 to the first parking position in response to receiving the park signal. That is, commands and/or signals are issued to the vehicle, specifically to a vehicle control system (not shown), to move to the first parking position, as shown in the example of FIG. 4, in response to the received signal from the operator. The vehicle 102, utilizing the autonomous driving system, aligns its orientation to the orientation of the first parking position.

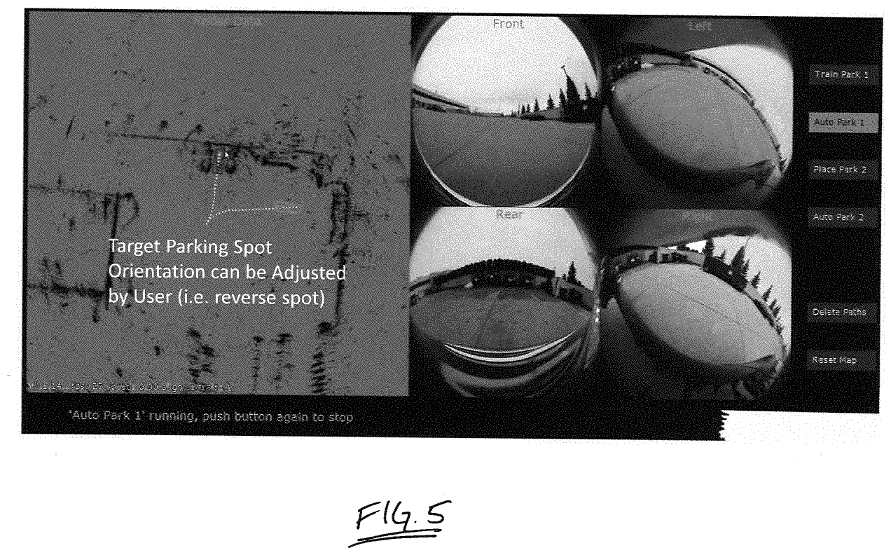

Referring now to FIG. 5, the orientation of the vehicle 102 in the first parking position may be changed. This change may be requested by the driver of the vehicle 102. For example, even though the vehicle 102 may have been parked in the first parking position a forward-facing direction (e.g., in step 206), it may be desired to have the vehicle 102 be autonomously parked in the first parking position in a rearward-facing direction.

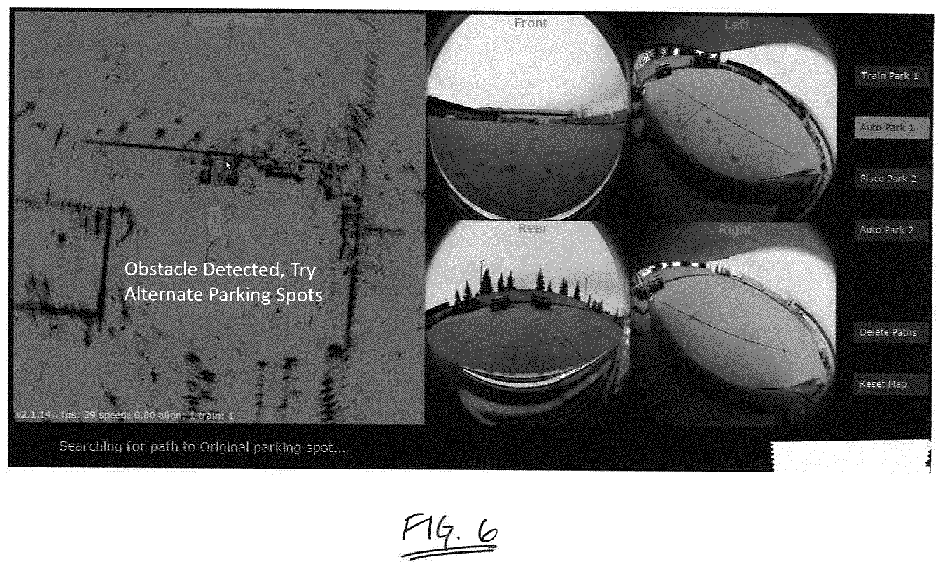

If obstacles are detected in or around the first parking position, the system 100 and method 200 may compensate for such obstacles. In one situation, if the obstacle is not in the first parking position, a route around the obstacles may be planned to avoid contact with the obstacle. In another situation, an alternative parking position may be utilized, as is shown in FIGS. 6-8. In yet another situation, the system 100 and method 200 may alert the driver of the obstacle.

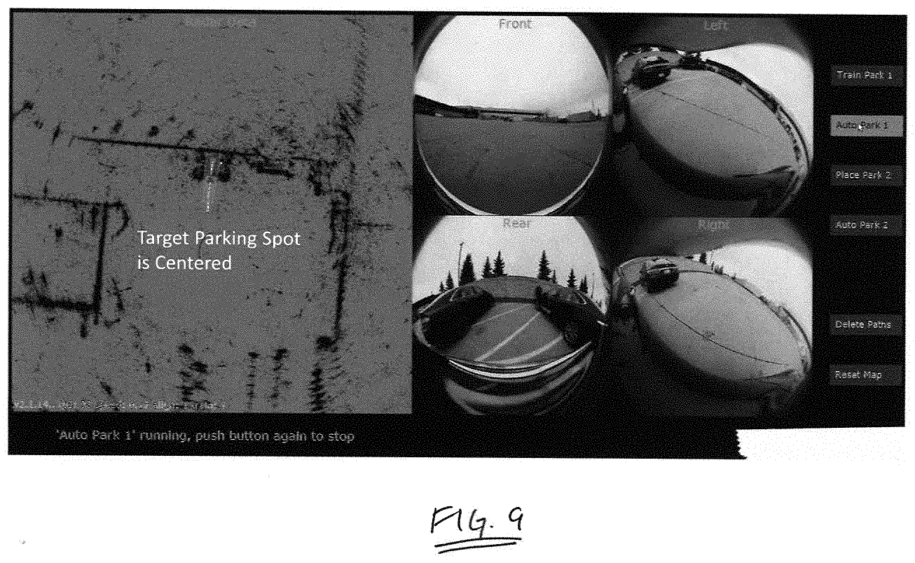

The method 200 may also include adjusting the first parking position during the autonomous movement of the vehicle into the first parking position based on data from the sensors 104 of the vehicle 102. In one exemplary embodiment, the first parking position is adjusted such that the vehicle 102 will be centered (see FIG. 9) in the space available, e.g., the space between obstacles or between lines indicated a parking space.

A second parking position may be stored in the data storage device 108. The second parking position may be considered a “pick-up” position, i.e., the location where the driver of the vehicle expects to join the vehicle. For example, the second parking position may be near the front door of a home or office building, in a porte cochere, at the end of a walkway, etc.

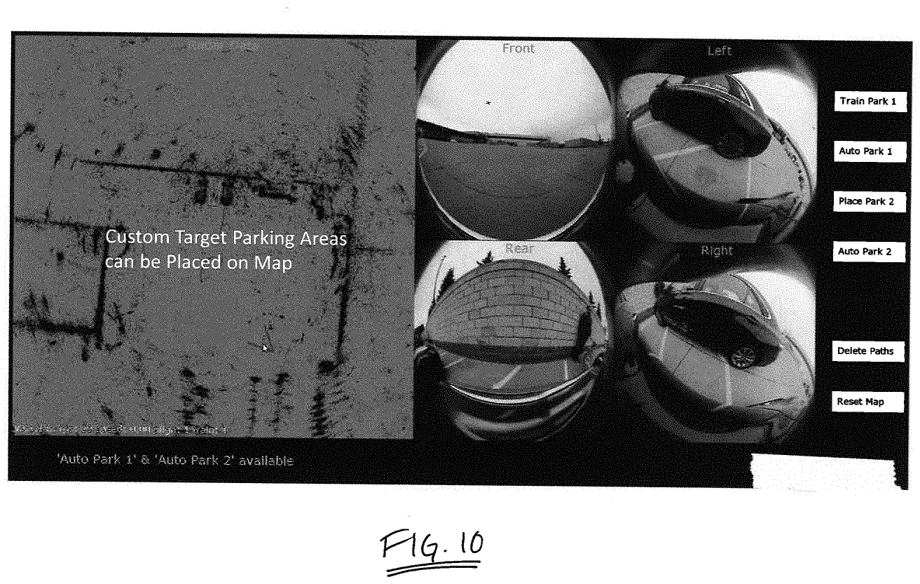

In one embodiment, the second parking position may be indicated on the map, as is shown in FIG. 10. In another embodiment, the second parking position may be learned by driving the car to the location and the operating issuing a second learn signal indicating that the vehicle is located in a second parking position. The method 200 may further include determining a second set of spatial data indicative of the location of the vehicle relative to the map in response to receiving the second learn signal. The method 200 may also include storing the second set of spatial data in the data storage device.

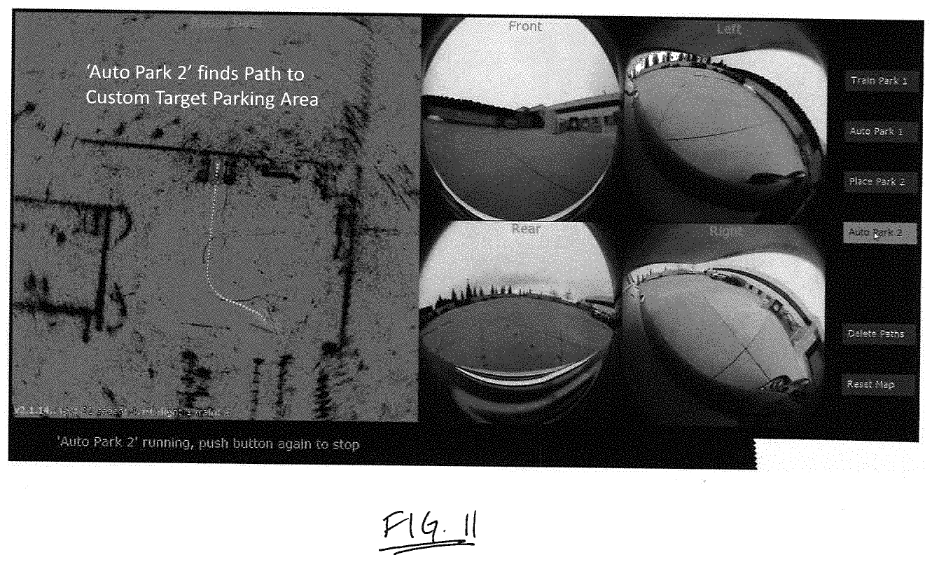

The method may also include receiving a retrieve signal indicating that an operator of the vehicle would like to retrieve the vehicle. In response to receiving the retrieve signal, the method continues with issuing commands to autonomously move the vehicle to the second parking position in response to receiving the retrieve signal, as shown in FIG. 11.

The present invention has been described herein in an illustrative manner, and it is to be understood that the terminology which has been used is intended to be in the nature of words of description rather than of limitation. Obviously, many modifications and variations of the invention are possible in light of the above teachings. The invention may be practiced otherwise than as specifically described within the scope of the appended claims.

1. A method of parking a vehicle comprising:
creating a map of a parking environment utilizing data from at least one sensor coupled to a vehicle;
storing the map in a data storage device;
receiving a first learn signal indicating that the vehicle is located in a first parking position;
determining a first set of spatial data indicative of the location of the vehicle relative to the map in response to receiving the first learn signal; and
storing the first set of spatial data in the data storage device.

2. The method as set forth in claim 1 further comprising receiving a park signal indicating that an operator of the vehicle would like the vehicle to autonomously move to the first parking position.

3. The method as set forth in claim 2 further comprising issuing commands to autonomously move the vehicle to the first parking position in response to receiving the park signal.

4. The method as set forth in claim 3 further comprising:
receiving a second learn signal indicating that the vehicle is located in a second parking position;
determining a second set of spatial data indicative of the location of the vehicle relative to the map in response to receiving the second learn signal; and
storing the second set of spatial data in the data storage device.

5. The method as set forth in claim 4 further comprising receiving a retrieve signal indicating that an operator of the vehicle would like to retrieve the vehicle.

6. The method as set forth in claim 5 further comprising issuing commands to autonomously move the vehicle to the second parking position in response to receiving the retrieve signal.

7. The method as set forth in claim 3 further comprising:
receiving a second set of spatial data indicative of a desired location of the vehicle with respect to the map; and
storing the second set of spatial data in the data storage device.

8. The method as set forth in claim 7 further comprising:
receiving a retrieve signal indicating that an operator of the vehicle would like to retrieve the vehicle; and
issuing commands to autonomously move the vehicle to the second parking position in response to receiving the retrieve signal.

9. A parking system for parking a vehicle, the parking system comprising:
a processor circuit and a data storage device communicatively coupled thereto, the processor circuit configured to:
create a map of a parking environment utilizing data from at least one sensor coupled to a vehicle;
store the map in the data storage device;
receive a first learn signal indicating that the vehicle is located in a first parking position;
determine a first set of spatial data indicative of the location of the vehicle relative to the map in response to receiving the first learn signal; and
store the first set of spatial data in the data storage device.

10. The parking system as set forth in claim 9, wherein the processor circuit is further configured to receive a park signal indicating that an operator of the vehicle would like the vehicle to autonomously move to the first parking position.

11. The parking system as set forth in claim 10, wherein the processor circuit is further configured to issue commands to autonomously move the vehicle to the first parking position in response to receiving the park signal.

12. The parking system as set forth in claim 11, wherein the processor circuit is further configured to:
receive a second learn signal indicating that the vehicle is located in a second parking position;
determine a second set of spatial data indicative of the location of the vehicle relative to the map in response to receiving the second learn signal; and
store the second set of spatial data in the data storage device.

13. The parking system as set forth in claim 12, wherein the processor circuit is further configured to receive a retrieve signal indicating that an operator of the vehicle would like to retrieve the vehicle.

14. The parking system as set forth in claim 13, wherein the processor circuit is further configured to issue commands to autonomously move the vehicle to the second parking position in response to receiving the retrieve signal.

15. The parking system as set forth in claim 11, wherein the processor circuit is further configured to:
receive a second set of spatial data indicative of a desired location of the vehicle with respect to the map; and
store the second set of spatial data in the data storage device.

16. The parking system as set forth in claim 15, wherein the processor circuit is further configured to:
receive a retrieve signal indicating that an operator of the vehicle would like to retrieve the vehicle; and
issue commands to autonomously move the vehicle to the second parking position in response to receiving the retrieve signal.
